(19) United States
(12) Patent Application Publication
(10) Pub. No.: US 2026/0182487 A1
(43) Pub. Date: Jul. 2, 2026

(54) CONTROLLERS AND CONTROL METHODS FOR EXERTION OF VEHICLE STEERING CONTROL

(71) Applicant: Kubota Corporation, Osaka (JP)

(72) Inventors: Yuji OKUYAMA, Sakai-shi (JP); Tomoya SUYAMA, Sakai-shi (JP); Masayoshi SUEFUJI, Sakai-shi (JP)

(21) Appl. No.: 19/432,329

(22) Filed: Dec. 24, 2025

(30) Foreign Application Priority Data
Dec. 27, 2024 (JP) 2024-231929

(51) Int. Cl. A01B 69/04

(52) U.S. Cl. CPC A01B 69/008

(57) ABSTRACT

A controller configured or programmed to control steering of a vehicle includes one or more processors, and one or more memories storing a computer program to be executed by the one or more processors to perform operations including obtaining sensor data from one or more sensors provided on the vehicle for use in determining a curvature of a route along which the vehicle is traveling, determining the curvature based on the sensor data, and correcting a steering angle of a steered wheel of the vehicle based on the curvature.

### CROSS REFERENCE TO RELATED APPLICATIONS

This application claims the benefit of priority to Japanese Patent Application No. 2024-231929 filed on Dec. 27, 2024. The entire contents of this application are hereby incorporated herein by reference.

### BACKGROUND OF THE INVENTION

### 1. Field of the Invention

The present disclosure relates to controllers and control methods for performing vehicle steering control.

### 2. Description of the Related Art

Research and development are underway to automate work vehicles such as agricultural tractors. For example, vehicles that travel by automatic steering, utilizing positioning devices such as GNSS (Global Navigation Satellite System) capable of precise positioning, have been put into practical use. Vehicles that automatically control speed in addition to automatic steering have also been put into practical use.

U.S. Pat. No. 11,572,074 discloses an example of the system of controlling an off-road vehicle (agricultural vehicle, construction vehicle, etc.) that performs self-traveling. The system disclosed in U.S. Pat. No. 11,572,074 has the function of estimating vehicle tire parameters (cornering stiffness, tire type, etc.) in real time. This system estimates the tire parameters based on the difference between the predicted vehicle position that is predicted based on the vehicle's motion characteristics and the measured position of the vehicle.

### SUMMARY OF THE INVENTION

A vehicle traveling by automatic steering uses various sensors to estimate its own position and orientation while traveling along a predetermined target route. To allow the vehicle to travel along the target route, it is required to precisely adjust the steering angle of the steered wheels (e.g., front wheels) so as to match the curvature of the target route. However, since the theoretical vehicle movement and the actual vehicle movement generally have differences, it is important to appropriately correct the steering angle based on the differences.

Example embodiments of the present invention provide vehicles each capable of correcting a steering angle in real time based on information obtained during normal traveling without requiring any special traveling to determine correction parameters for steering angle correction, and a controllers and control methods for such vehicles.

The present disclosure provides the solutions described in the following items.

### [Item 1]

A controller for controlling steering of a vehicle, the controller including one or more processors, and one or more memories storing a computer program to be executed by the one or more processors, wherein the one or more processors is/are configured or programmed to execute the computer program to perform operations including obtaining sensor data from one or more sensors provided on the vehicle for use in determining a curvature of a route along which the vehicle is traveling, determining the curvature based on the sensor data, and correcting a steering angle of a steered wheel of the vehicle based on the curvature.

### [Item 2]

The controller of Item 1, wherein the one or more processors is/are configured or programmed to correct the steering angle based on the curvature and a wheelbase of the vehicle.

### [Item 3]

The controller of Item 1 or 2, wherein the one or more sensors include a vehicle speed sensor to measure a traveling speed of the vehicle, and an angular velocity sensor to measure an angular velocity about a yaw axis of the vehicle, wherein the one or more processors is/are configured or programmed to determine the curvature based on the traveling speed and the angular velocity.

### [Item 4]

The controller of Item 3, wherein the one or more processors is/are configured or programmed to determine the curvature based on a relationship κ=ω/v where v is the traveling speed, ω is the angular velocity, and κ is the curvature.

### [Item 5]

The controller of Item 4, wherein the one or more processors is/are configured or programmed to determine a first error coefficient α and a second error coefficient β based on a relationship κ=tan(δ×β+α)/L . . . (Equation 1), where δ is the steering angle of the vehicle before correction, L is the wheelbase, α is the first error coefficient, and β is the second error coefficient, and the one or more processors is/are configured or programmed to correct the steering angle based on the first error coefficient α and the second error coefficient β.

### [Item 6]

The controller of Item 5, wherein the one or more sensors include a steering angle sensor to measure the steering angle of the vehicle, the one or more processors is/are configured or programmed to determine the curvature κ based on the traveling speed v and the angular velocity ω during a period in which the vehicle is traveling while an absolute value of the measured steering angle is smaller than a first threshold, and the one or more processors is/are configured or programmed to determine the first error coefficient α based on a relationship κ=tan(α)/L obtained by substituting δ=0 into Equation 1.

### [Item 7]

The controller of Item 6, wherein the one or more processors is/are configured or programmed to determine the second error coefficient β based on the determined first error coefficient α, the curvature κ determined based on the traveling speed v and the angular velocity ω during a period in which the vehicle is traveling while the absolute value of the steering angle is greater than a second threshold, and Equation 1.

### [Item 8]

The controller of any one of Items 5 to 7, wherein the one or more processors is/are configured or programmed to continuously update the first error coefficient α and the second error coefficient β while the vehicle is traveling and correct the steering angle based on the updated first error coefficient α and the updated second error coefficient β.

### [Item 9]

The controller of any one of Items 1 to 8, wherein the one or more processors is/are configured or programmed to select a portion of the sensor data obtained while the vehicle is traveling, to be used in determining the curvature, based on contents of the sensor data and/or a travel condition of the vehicle.

### [Item 10]

The controller of any one of Items 1 to 9, wherein the vehicle is capable of operating in an automatic steering mode, and the one or more processors is/are configured or programmed to determine a steering command angle based on a target route and a position of the vehicle, determine a steering angle correction parameter based on the curvature, correct the steering command angle based on the steering angle correction parameter, and control steering of the vehicle based on the corrected steering command angle.

### [Item 11]

The controller of any one of Items 1 to 9, wherein the vehicle is capable of operating in an automatic steering mode, and in the automatic steering mode, the one or more processors is/are configured or programmed to obtain information indicative of a measured position of the vehicle from a positioning device provided on the vehicle, retrieve information indicative of a target route of the vehicle from a storage, determine a steering command angle based on the measured position and the target route, determine a steering angle correction parameter based on the curvature, correct the steering command angle based on the steering angle correction parameter, and control steering of the vehicle based on the corrected steering command angle.

### [Item 12]

The controller of any one of Items 1 to 11, wherein the vehicle is an agricultural tractor.

### [Item 13]

A vehicle including the controller as set forth in any one of Items 1 to 12, the one or more sensors, a drivetrain including a steered wheel, and an actuator to drive the steered wheel based on an instruction from the controller.

### [Item 14]

A method executed by one or more computers to control steering of a vehicle, the method including obtaining sensor data from one or more sensors provided on the vehicle for use in determining a curvature of a route along which the vehicle is traveling, determining the curvature based on the sensor data, and correcting a steering angle of a steered wheel of the vehicle based on the curvature.

### [Item 15]

A non-transitory computer-readable medium including a computer program executable by one or more computers to control steering of a vehicle, the computer program causing the one or more computers to obtain sensor data from one or more sensors provided on the vehicle for use in determining a curvature of a route along which the vehicle is traveling, determine the curvature based on the sensor data, and correct a steering angle of the vehicle based on the curvature.

General or specific example embodiments of the present disclosure may be realized by an apparatus, system, method, integrated circuit, computer program, or computer readable non-transitory storage medium, or any combination thereof. The computer readable storage medium may include a volatile storage medium or a nonvolatile storage medium. The apparatus may include a plurality of apparatuses. Where the apparatus includes two or more apparatuses, the two or more apparatuses may be arranged within a single device or may be arranged separately within two or more separate devices.

According to an example embodiment of the present invention, it is possible to correct the steering angle in real time based on information obtained during normal traveling without requiring any special traveling to determine the correction parameters for steering angle correction.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a block diagram showing a general configuration of a vehicle according to an example embodiment of the present invention.

FIG. 2 is a flowchart showing an example of an operation performed by a processor of a controller.

FIG. 3A schematically shows the steering angle offset error that can occur when a vehicle is traveling straight.

FIG. 3B schematically shows the steering angle scale factor error that can occur when a vehicle is making a turn.

FIG. 4 shows an example of the vehicle geometry in a front-wheel steering vehicle.

FIG. 5 is a flowchart showing an example of the method of determining the correction parameters by the processor of the controller.

FIG. 6 is a perspective view showing an example of the appearance of a work vehicle.

FIG. 7 is a side view schematically showing an example of the work vehicle and an implement linked to the work vehicle.

FIG. 8 is a block diagram showing an example schematic configuration of the work vehicle and an implement.

FIG. 9 is a conceptual diagram showing an example of the work vehicle to perform positioning using RTK-GNSS.

FIG. 10 is a schematic diagram showing an example of an operation terminal and operation switches provided inside the cabin.

FIG. 11 is a block diagram showing an example hardware configuration of an ECU (controller).

FIG. 12A is a diagram showing an example of how the work vehicle travels in the automatic steering mode.

FIG. 12B is a diagram showing another example of how the work vehicle travels in the automatic steering mode.

FIG. 12C is a diagram showing yet another example of how the work vehicle travels in the automatic steering mode.

FIG. 13 is a diagram schematically showing an example of a target route for the work vehicle traveling in a field by automatic steering.

FIG. 14 is a flowchart showing an example of an operation performed by a controller during automatic steering.

FIG. 15A is a diagram showing an example of the work vehicle traveling along a target route.

FIG. 15B is a diagram showing an example of the work vehicle located at a position shifted to the right from the target route.

FIG. 15C is a diagram showing an example of a work vehicle located at a position shifted to the left from the target route.

FIG. 15D is a diagram showing an example of the work vehicle oriented in a direction inclined relative to the target route.

### DETAILED DESCRIPTION OF THE EXAMPLE EMBODIMENTS

Hereinafter, example embodiments of the present disclosure will be described. Note, however, that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. Note that the accompanying drawings and the following description, which are provided by the present inventors so that those skilled in the art can sufficiently understand the present disclosure, are not intended to limit the scope of the claims. In the following description, elements having identical or similar functions are denoted by identical reference numerals.

The following example embodiments are only examples, and the techniques according to the present disclosure are not limited to the following example embodiments. For example, numerical values, shapes, steps, orders of steps, layout of a display screen, etc., which are indicated in the following example embodiments are only examples, and admit of various modifications. Any one implementation may be combined with another.

In this specification, “self-driving” refers to controlling travel of a vehicle by the action of a controller, rather than through manual operations of a driver (operator). During self-driving, not only travel of the vehicle, but also the operation of work (e.g., the operation of the implement) may be controlled automatically. Travel of a vehicle via self-driving will be referred to as “self-traveling”. The controller may control at least one of: steering that is required in travel of a vehicle, adjustment of the traveling speed, or beginning and ending of travel. Steering of a vehicle through the action of a controller without manual operation by a driver is referred to as “automatic steering”. In the case of controlling a work vehicle having an implement attached thereto, the controller may control operations such as raising or lowering of the implement, beginning and ending of an operation of the implement, and so on. A travel based on self-driving may include not only traveling of a vehicle that goes along a predetermined route toward a destination, but also traveling of a vehicle that follows a target of tracking. A vehicle that performs self-driving may operate not only in a self-driving mode but also in a manual driving mode, where the vehicle travels through manual operations of a driver. A travel of a vehicle through manual operations of a driver is referred to as “manual traveling”. The “manual operations of a driver” include not only manual operations of a driver on a vehicle but also remote operations of a driver outside a vehicle. A vehicle that performs self-driving may also travel partly based on the driver's manual operations. A portion of, or the entirety of, the controller may reside outside the vehicle. Control signals, commands, data, etc., may be communicated between the vehicle and a controller residing outside the vehicle. A vehicle that performs self-driving may travel autonomously while sensing the surrounding environment, without any person being involved in the controlling of the travel of the vehicle. A vehicle that is capable of autonomous traveling is able to travel in an unmanned manner. During an autonomous travel, operations of detecting and avoiding obstacles can be performed.

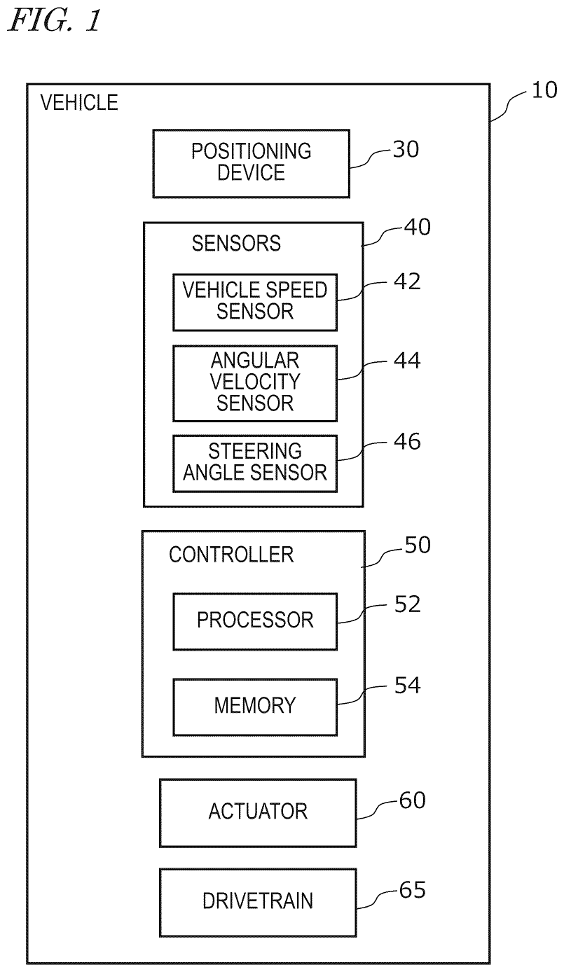

FIG. 1 is a block diagram showing a general configuration of a vehicle 10 according to an exemplary example embodiment of the present invention. The vehicle 10 can be a work vehicle for agriculture, such as an agricultural tractor. Note that the vehicle 10 is not limited to an agricultural work vehicle but may be any other type of vehicle, such as a construction vehicle, a truck, or a passenger car.

The vehicle 10 shown in FIG. 1 includes a positioning device 30, sensors 40, a controller 50, an actuator 60, and a drivetrain 65. The positioning device 30 measures the position of the vehicle 10 and outputs information indicative of the measured position. The sensors 40 include, for example, various sensors such as a vehicle speed sensor 42, an angular velocity sensor 44, and a steering angle sensor 46. The vehicle 10 may include an inertial measurement unit (IMU) that includes the vehicle speed sensor 42 and the angular velocity sensor 44. The controller 50 includes one or more processors 52 and one or more memories 54. The drivetrain 65 includes various components necessary for travel, such as four wheels (i.e., two front wheels and two rear wheels) and front and rear axles, for example. The drivetrain 65 includes, for example, two front wheels as drive wheels. The actuator 60 is configured to drive the steered wheels according to instructions from the controller 50.

The controller 50 can be configured or programmed to operate both in the automatic steering mode and the manual steering mode. The controller 50 can be configured or programmed to switch between the automatic steering mode and the manual steering mode in response to an operation by a driver, for example. In the automatic steering mode, the controller 50 is configured or programmed to control the steering of the steered wheels (e.g., the left and right front wheels) included in the drivetrain 65 via the actuator 60 such that the vehicle 10 travels along a target route based on the position of the vehicle 10 specified by the positioning device 30 and the target routes stored in a storage such as the memory 54.

The positioning device 30 is placed inside or outside the vehicle 10. The positioning device 30 can include, for example, a GNSS receiver. The positioning device 30 specifies the position of the vehicle 10 based on signals from a plurality of GNSS satellites and outputs time series position data. The positioning device 30 may include devices other than the GNSS receiver, such as LiDAR sensors or cameras. By matching data acquired by LiDAR sensors or cameras with a pre-prepared environment map, the position of the vehicle 10 can be estimated. The target route is a route that is set within the area where the vehicle 10 travels and is used as a target for travel. The target route can be set, for example, based on inputs by a user before automatic steering driving begins and can be stored in a storage such as the memory 54. When the vehicle 10 is an agricultural vehicle such as a tractor, the target route can be set within a field and/or farm roads outside the field.

The controller 50 may be a computer configured or programmed to perform steering control for automatic steering. The controller 50 can be, for example, an electronic control unit (ECU) provided in the vehicle 10. At least some of the functions of the controller 50 may be realized by a device provided outside the vehicle 10. That is, the functions of the controller 50 may be realized by a group of multiple computers provided inside or outside the vehicle 10.

As shown in FIG. 1, the controller 50 includes one or more processors 52 and one or more memories 54. FIG. 1 illustrates a single processor 52 and a single memory 54, although a plurality of processors and/or a plurality of memories may be provided in the controller 50. The memory 54 stores computer programs that are to be executed by the processor 52, data that are to be referenced by the processor 52, and data generated by the processor 52. The processor 52 can be configured or programmed to execute operations including the steering control of the vehicle 10 by executing computer programs stored in the memory 54.

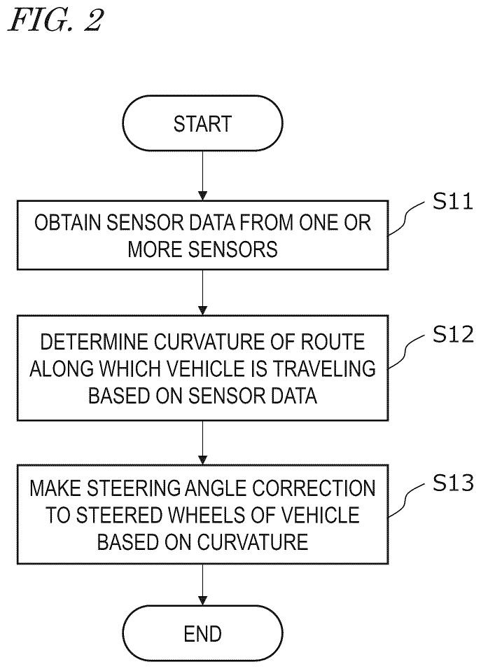

FIG. 2 is a flowchart showing an example of an operation performed by the processor 52 of the controller 50. In the example shown in FIG. 2, the processor 52 executes the programs stored in the memory 54, thus executing the following operations:
obtaining sensor data, which are to be used to determine the curvature of the route along which the vehicle 10 is traveling, from one or more sensors included in the sensors 20 installed on the vehicle 10 (Step S11);
determining the curvature of the route along which the vehicle 10 is traveling based on the obtained sensor data (Step S12); and
making a steering angle correction to the steered wheels of the vehicle 10 based on the determined curvature (Step S13).

“One or more sensors” can be, for example, the vehicle speed sensor 42 and the angular velocity sensor 44. These sensors enable measurement of the traveling speed of the vehicle 10 (also referred to as “vehicle speed”) and measurement of the angular velocity of the vehicle 10 about the yaw axis (also referred to as “yaw rate”). As will be described later, the processor 52 can determine the curvature of the route along which the vehicle 10 is traveling (hereinafter, also referred to as “travel curvature”) based on the traveling speed measured by the vehicle speed sensor 42 and the angular velocity (yaw rate) measured by the angular velocity sensor 44.

The processor 52 may determine the curvature using signals from sensors other than the vehicle speed sensor 42 and the angular velocity sensor 44. For example, when the sensors 40 include an accelerometer, the processor 52 may determine the curvature based on the measurement values of the accelerometer. Alternatively, when the positioning device 30 is capable of high-precision positioning such as RTK-GNSS, the processor 52 may determine the traveling curvature of the vehicle 10 based on the change over time of the position measured by the positioning device 30.

The “steering angle correction” is the process of correcting the instruction values for the steering angle of the steered wheels (e.g., the left and right front wheels) of the vehicle 10, thus adjusting the steering angle such that the vehicle can travel at the target curvature. As will be described later, the processor 52 can correct the steering angle based on the curvature determined at Step S12 and the wheelbase of the vehicle 10.

If the vehicle 10 is capable of operating in the automatic steering mode, the processor 52 can be configured or programmed to perform the following operations in the automatic steering mode:
obtaining information indicative of the measured position of the vehicle 10 from the positioning device 30;
retrieving information indicative of the target route of the vehicle 10 from the storage (e.g., the memory 54);
determining the steering command angle based on the measured position and the target route according to a predetermined algorithm.
obtaining the front wheel steering angle value for the vehicle 10 from the steering angle sensor 46;
determining the steering angle correction parameters based on the curvature determined at Step S12 and the front wheel steering angle obtained from the steering angle sensor 46;
correcting the steering command angle based on the determined steering angle correction parameters; and
exerting the vehicle steering control based on the corrected steering command angle.

The “steering angle correction parameters” are parameters for use in steering angle correction. The steering angle correction parameters can include, for example, error coefficients α and β, which will be described later, or any parameters derived from the error coefficients.

On the other hand, in manual steering mode, the steering angle correction is not made, but it is possible to perform the process of determining the steering angle correction parameters for use in the automatic steering mode. In manual steering mode, the processor 52 can be configured or programmed to perform the following operations:
obtaining the front wheel steering angle values for the vehicle 10, which vary based on the driver's steering operation, from the steering angle sensor 46;
determining the steering angle correction parameters based on the curvature determined at Step S12 and the front wheel steering angle obtained from the steering angle sensor 46 and storing the determined steering angle correction parameters in the storage.

Through the above operations, the controller 50 can obtain the steering angle correction parameters for optimization of the steering angle in the automatic steering mode based on the actual curvature of the route along which the vehicle 10 is traveling. This enables real-time steering angle correction during normal traveling without requiring any special traveling to determine the correction values for the steering angle correction.

As previously described, the theoretical vehicle movement and the actual vehicle movement generally have differences. For example, due to various factors such as ground irregularities, component mounting errors, sensor detection errors, etc., the curvature during travel of the vehicle 10 may deviate from the curvature calculated based on the theoretical vehicle movement. Therefore, to allow the vehicle to travel along the target route, it is necessary to appropriately determine the steering angle correction values such that the differences between the theoretical vehicle movement and the actual vehicle movement are reduced.

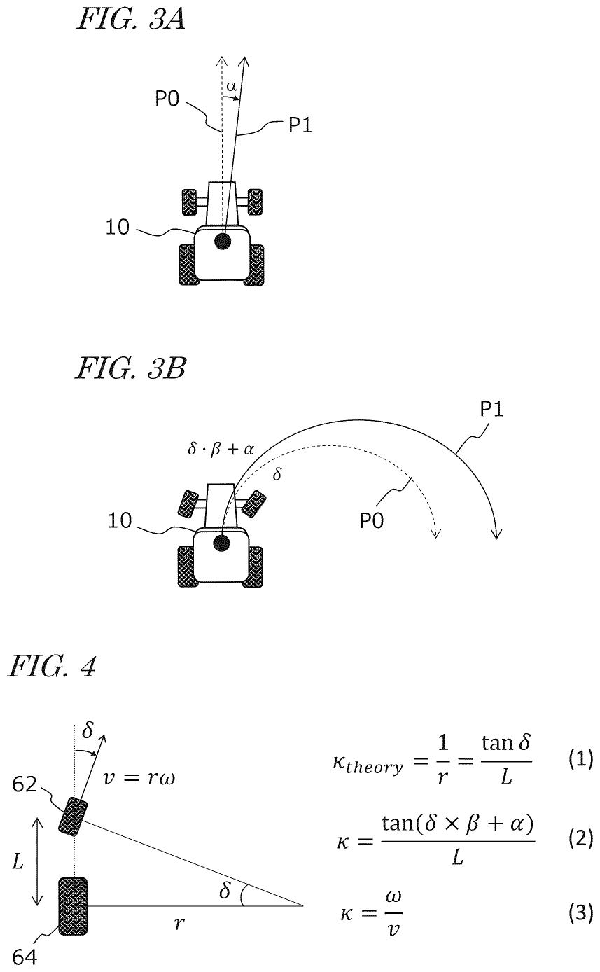

Examples of the correction values include the straight-travel correction value that is for correcting the offset error during straight travel of the vehicle and the turn correction value that is for correcting the scale factor error during turning. Hereinafter, these errors and correction values will be described with reference to FIG. 3A and FIG. 3B.

FIG. 3A schematically shows the steering angle offset error that can occur when a vehicle 10 is traveling straight. FIG. 3B schematically shows the steering angle scale factor error that can occur when a vehicle 10 is making a turn. In FIG. 3A and FIG. 3B, the target route P0 is illustrated by a dashed arrow, and the actual route P1 of the vehicle 10 is illustrated by a solid arrow. The steering angle corresponding to the target route P0 is denoted by δ. The coefficient for the offset error during straight traveling (first error coefficient) is denoted by α. The coefficient for the scale factor error during turning (second error coefficient) is denoted by β.

As shown in FIG. 3A, even if the steering command angle is set to 0 degrees (δ=0) to allow the vehicle 10 to travel straight, the actual path of the vehicle 10 may correspond to the path taken when the steering angle is α(≠0) due to the offset error. As shown in FIG. 3B, even if the steering command angle is set to δ to allow the vehicle 10 to make a turn along a predetermined target route P0, the actual path of the vehicle 10 may correspond to the path taken when the steering angle is δ×β+α due to the scale factor error and the offset error. Therefore, it is advantageous to correct the steering command angle such that the effects of these errors are eliminated. Correction to the steering command angle can be realized by specifying the coefficients α and β and correcting the steering command angle, for example, from δ to δ′=(δ−α)/β, using the specified values.

Traditionally, to address the above issues, a special mode has been implemented in vehicles, separate from the normal driving mode, to determine the correction parameters such as the coefficients α and β. In such a mode, a vehicle is driven to manually or automatically travel along one of several predetermined routes, such as a straight route or an arc-shaped route with a predetermined curvature, and the correction parameters are determined based on the data obtained during the travel of the vehicle. For example, a vehicle is driven to manually or automatically travel along a straight route, and the offset error coefficient α can be determined based on the instruction value or measurement value for the steering angle during the travel. Additionally, the vehicle is driven to travel at a predetermined steering angle, and the scale factor error coefficient β can be determined based on the curvature of the actually traveled path measured during the travel (hereinafter, also referred to as “traveling curvature”), the steering command angle, and the previously determined coefficient α. The operation of driving a vehicle to travel in such a special mode to determine the correction parameters can be performed, for example, by the manufacturer or dealer prior to sale of the vehicle, or by a service provider or user during maintenance, modification, or repair.

The appropriate correction parameters can vary among individual vehicles. Furthermore, it can vary even in the same individual vehicle due to deterioration over time, modifications, or repairs in the vehicle body. Therefore, it is necessary to appropriately update the correction parameters. However, the process of determining or updating the correction parameters using such special modes is troublesome and requires 10 or more minutes per instance even if performed by an experienced operator. If the operation is not appropriately performed, the correction parameters will not be updated properly and, consequently, the accuracy or precision of the steering control can deteriorate.

Thus, the present disclosure provides a method for automatically determining the correction parameters based on information obtained during usual travelling of the vehicle 10. This enables determination of the correction parameters without performing predetermined operations that will be necessary in a conventional method with the use of the mode for acquisition of the correction parameters.

Now, a steering angle correction method according to the present example embodiment is described more specifically with reference to FIG. 4.

FIG. 4 shows an example of the vehicle geometry in a front-wheel steering vehicle having an Ackermann-Jeantaud mechanism. FIG. 4 shows a front wheel 62 and a rear wheel 64 included in the drivetrain of the vehicle, which are on the outside during turning. Herein, r is the turning radius of the vehicle, L is the distance between the axle of the front wheel 62 and the axle of the rear wheel 64 (i.e., wheelbase), and δ is the steering angle of the front wheel 62 (i.e., steered wheel). The theoretical traveling curvature κ_{theory} based on the vehicle geometry is calculated by the following equation (1).

$$\begin{matrix}Equation 1 & \\ {κ}_{theory} = \frac{1}{r} = \frac{tan δ}{L} & ( 1 )\end{matrix}$$

In actual vehicles, due to various factors such as tire slip or mounting errors of components such as actuators or sensors, Equation (1) does not necessarily hold true. The actual traveling curvature κ of the vehicles can be expressed by Equation (2) shown below, which includes, for example, the aforementioned error coefficients α and β.

$$\begin{matrix}Equation 2 & \\ κ = \frac{tan ( δ \times β + α )}{L} & ( 2 )\end{matrix}$$

Herein, a represents the offset error coefficient that causes a curvature error when the steering angle δ is zero (0), and β represents the scale factor error coefficient that causes a curvature error proportional to the steering angle δ. The error coefficients α and β relate to the straight-travel correction value and the turn correction value, respectively.

On the other hand, Equation (3) shown below holds between the speed of a traveling vehicle, v, the angular velocity about the yaw axis (yaw rate), ω, and the traveling curvature κ.

$$\begin{matrix}Equation 3 & \\ κ = \frac{ω}{v} & ( 3 )\end{matrix}$$

The processor 52 of the controller 50 of the present example embodiment can be configured or programmed to determine the error coefficients α and β based on the relationships of Equation (1) to Equation (3), the vehicle speed v, the angular velocity ω, and the steering angle δ while the vehicle 10 is traveling in the manual or automatic driving mode. The vehicle speed v can be measured by the vehicle speed sensor 42. The angular velocity ω can be measured by the angular velocity sensor 44. When the vehicle 10 is traveling under automatic steering, the steering angle δ can be the steering command angle determined by the processor 52 according to a predetermined algorithm based on the current position and orientation of the vehicle 10 and the target route. When the vehicle 10 is traveling under manual steering, the steering angle δ may be the front wheel steering angle value determined based on the driver's steering operation.

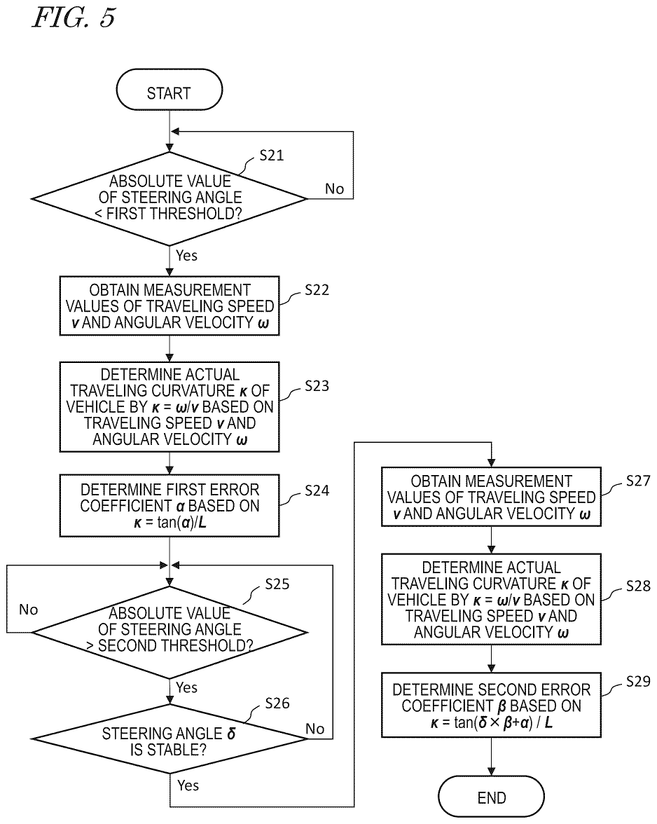

The processor 52 can determine the correction parameters (error coefficients α and β) through the process shown in FIG. 5, for example. FIG. 5 is a flowchart showing an example of the method of determining the error coefficients α and β by the processor 52 of the controller 50. The operation shown in FIG. 5 is performed when the vehicle 10 is traveling in the automatic or manual driving mode. The travel route of the vehicle 10 is arbitrary. In the example of FIG. 5, the processor 52 is configured or programmed to perform the following operations.

At Step S21, the processor 52 determines whether or not the absolute value of the steering angle is smaller than the first threshold. The steering angle may be the value measured by the steering angle sensor 46 or, in the case of automatic driving, the steering command angle determined by the processor 52. The first threshold can be set to a positive value close to zero. For example, the first threshold can be set to a value in the range of 0.01° to 1°. That is, the processor 52 determines whether or not the vehicle 10 is traveling with the steering angle δ at substantially zero. Based on this determination, the processor 52 detects the section where the vehicle 10 is traveling straight. If the steering angle δ is smaller than the first threshold, the process proceeds to Step S22. The operation of Step S21 is repeated until the processor 52 determines that the steering angle δ is smaller than the first threshold. Note that the processor 52 may proceed to Step S22 after the steering angle δ remains smaller than the first threshold for a predetermined period of time (e.g., several seconds) or longer, rather than proceeding to Step S22 immediately after the processor 52 determines that the steering angle δ is smaller than the first threshold.

At Step S22, the processor 52 obtains the measurement values of the traveling speed v and the angular velocity ω of the vehicle 10. The processor 52 obtains the measurement value of the traveling speed v from the vehicle speed sensor 42 and obtains the measurement value of the angular velocity ω from the angular velocity sensor 44.

At Step S23, the processor 52 determines the actual traveling curvature κ of the vehicle 10 using the relationship of Equation (3) based on the traveling speed v and the angular velocity ω.

At Step S24, the processor 52 determines the first error coefficient α based on the traveling curvature κ determined at Step S23 and the relationship of κ=tan(α)/L obtained by substituting δ=0 into Equation (2). Herein, the wheelbase L is a known value and is stored beforehand in a storage such as the memory 54. The processor 52 stores the determined coefficient α in the storage.

At Step S25, the processor 52 determines whether or not the absolute value of the steering angle measured by the steering angle sensor 46 or the steering command angle is greater than the second threshold. Based on this determination, the processor 52 detects a section where the vehicle 10 is making a turn. The second threshold may be the same value as the first threshold mentioned above or may be a value greater than the first threshold. The second threshold can be set to a value within the range of, for example, 0.01° to 30°. If the steering angle δ is greater than the second threshold, the process proceeds to Step S26. The operation of Step S25 is repeated until the steering angle δ is determined to be greater than the threshold.

At Step S26, the processor 52 determines whether or not the variation over time of the steering angle δ is small and stable. For example, the processor 52 may determine whether or not the steering angle δ is stable by determining whether or not the average time variation rate of the steering angle δ over a predetermined time period is smaller than a threshold that is close to zero. If the steering angle δ is stable, the process proceeds to Step S27. If the steering angle δ is not stable, the process returns to Step S25.

At step S27, the processor 52 obtains the measurement values of the traveling speed v and the angular velocity ω of the vehicle 10. The processor 52 obtains the measurement value of the traveling speed v from the vehicle speed sensor 42 and obtains the measurement value of the angular velocity ω from the angular velocity sensor 44.

At Step S28, the processor 52 determines the actual traveling curvature κ of the vehicle 10 using the relationship of Equation (3) based on the traveling speed v and the angular velocity ω.

At Step S29, the processor 52 determines the second error coefficient β based on the first error coefficient α determined at Step S24, the traveling curvature κ determined at Step S27, and the relationship of Equation (2). The processor 52 stores the determined coefficient β in the storage.

After completion of Step S29, the processor 52 can initiate automatic steering control, which includes the steering angle correction with the use of the determined error coefficients α and β. For example, the processor 52 can realize steering control with reduced effects of the offset error and the scale factor error by correcting the steering angle δ (instruction value) to δ′ that is calculated by δ′=(δ−α)/β.

The operation shown in FIG. 5 may be repeatedly executed while the vehicle 10 is traveling. The processor 52 may determine the final coefficients α and β by the process of temporally averaging each of the coefficients α and β repeatedly calculated over a predetermined time period. For example, the coefficient α may be calculated multiple times by repeating the processes from Step S22 to Step S24 during the period where the vehicle 10 is substantially traveling straight, and the average for these calculated values may be determined as the final coefficient α. Likewise, the coefficient β may be calculated multiple times by repeating the processes from Step S27 to Step S29 during the period where the variation over time of the steering angle δ is small, and the average for these calculated values may be determined as the final coefficient β. The processor 52 may perform the operation of determining the coefficients α and β at regular intervals during traveling of the vehicle 10 or only within a relatively short time period after the vehicle 10 starts traveling. Alternatively, the processor 52 may perform the operation of determining the coefficients α and β at a timing specified by a user.

The processor 52 may continuously update the first error coefficient α and the second error coefficient β while the vehicle 10 is traveling and correct the steering angle based on the updated first error coefficient α and the updated second error coefficient β. This enables real-time optimization of the steering angle according to the changes in the conditions of the traveling vehicle 10 or the surrounding environment.

The processor 52 may select a portion of the sensor data obtained while the vehicle 10 is traveling, to be used in determining the curvature, according to the contents of the sensor data and/or the travel conditions of the vehicle 10. For example, the processor 52 may determine the curvature using only a portion of the data from the vehicle speed sensor 42 and/or the angular velocity sensor 44 which is acquired during a period where at least one of the vehicle speed, the acceleration, or the angular velocity meets a predetermined condition. The predetermined condition can include, for example, at least one of the following conditions: the vehicle speed is lower than the reference speed, the time variation rate of the acceleration is lower than the reference value, and the time variation rate of the angular velocity is lower than the reference value. This enables more accurate determination of the curvature based on the sensor data acquired during a period where the variation of the curvature is small or a period where the acceleration or deceleration is small.

Through the above operations, the processor 52 can determine the error coefficients α and β while the user ordinarily drives the vehicle 10 to travel, without driving the vehicle 10 to travel in any special mode for determination of the error coefficients α and β. Since the information necessary for the steering angle correction can be collected during ordinary traveling of the vehicle 10, driving in a special mode, which is conventionally necessary, can be eliminated.

According to conventional methods, information acquired during driving along a predetermined travel path is post-processed to calculate the actual traveling curvature with high precision, so that the parameters for the steering angle correction can be obtained. On the other hand, when driving along a predetermined travel path is not performed as in the present example embodiment, it is necessary to acquire the actual traveling curvature while it is uncertain what route a driver is to take for traveling, and the method of acquiring the actual traveling curvature in real time, rather than through post-processing, is necessary. In the present example embodiment, the relationship of Equation (3) may be additionally used so that the actual traveling curvature can be dynamically estimated based on the information obtained from the vehicle speed sensor 42 and the angular velocity sensor 44. Due to this feature, it is not necessary to perform a driving operation along a predetermined travel path, so that the convenience can be improved. In the present example embodiment, the correction parameters can be continuously updated through ordinary traveling, and the update is not limited to the timing of vehicle maintenance, repair, or modification. As a result, decrease of the steering control precision due to deterioration over time can be substantially prevented, and the need for users to perform the operations of periodically updating the correction parameters can be eliminated.

Next, more specific example embodiments will be described in which the techniques of the present disclosure are applied to an agricultural work vehicle, which is an example of the vehicle 10.

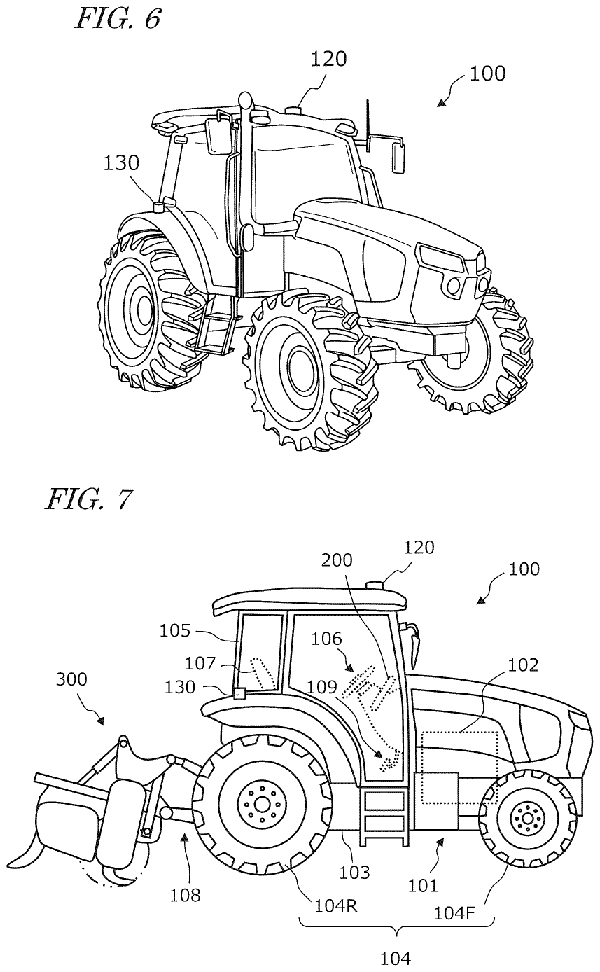

FIG. 6 is a perspective view showing an example of the appearance of a work vehicle 100. FIG. 7 is a side view schematically showing an example of the work vehicle 100 and an implement 300 linked to the work vehicle 100. The work vehicle 100 of the present example embodiment is a tractor for use in a field. The work vehicle 100 has an automatic steering function.

The work vehicle 100 of the present example embodiment includes a positioning device 120 and one or more obstacle sensors 130. While one obstacle sensor 130 is illustrated in FIG. 7, the obstacle sensor 130 may be provided at a plurality of locations on the work vehicle 100. Note that the obstacle sensor 130 is provided when necessary. If the obstacle sensor 130 is not needed, the work vehicle 100 may not include the obstacle sensor 130.

As shown in FIG. 7, the work vehicle 100 includes a vehicle body 101, a prime mover (engine) 102, and a transmission 103. The vehicle body 101 includes wheels 104 with tires and a cabin 105. The wheels 104 include a pair of front wheels 104F and a pair of rear wheels 104R. These wheels 104, together with the front and rear axles, are components of the drivetrain. A driver seat 107, a steering device 106, a plurality of pedals 109, an operation terminal 200, and operation switches are provided inside the cabin 105. One or both of the front wheels 104F and the rear wheels 104R may be replaced with crawlers, which are realized by a plurality of wheels with an endless track attached thereto, rather than wheels with tires.

The positioning device 120 of the present example embodiment includes a GNSS receiver. The GNSS receiver may include an antenna that receives signals from GNSS satellites and a processor that determines the position of the work vehicle 100 based on the signals received by the antenna. The positioning device 120 receives GNSS signals transmitted from a plurality of GNSS satellites and performs positioning based on the GNSS signals. GNSS is a generic term for satellite positioning devices such as GPS (Global Positioning System), QZSS (Quasi-Zenith Satellite System, e.g., MICHIBIKI), GLONASS, Galileo, and BeiDou. While the positioning device 120 of the present example embodiment is provided at the top of the cabin 105, it may be provided at other locations.

The positioning device 120 may include other types of devices such as a LiDAR sensor or a camera (including an image sensor) instead of or in addition to the GNSS receiver. If there are geographic objects in the environment in which the work vehicle 100 is traveling that function as characteristic points, the position of the work vehicle 100 can be estimated with high accuracy based on data acquired by the LiDAR sensor or the camera and the environment map stored in the storage 170 in advance. The LiDAR sensor or the camera may be used in conjunction with the GNSS receiver. By using data acquired by the LiDAR sensor or the camera to correct or complement position data based on GNSS signals, it is possible to identify the position of the work vehicle 100 with a higher accuracy.

The prime mover 102 may be a diesel engine, for example. An electric motor may be used instead of a diesel engine. The transmission 103 can vary the propulsion and traveling speed of the work vehicle 100 by changing the gear. The transmission 103 can also switch between forward and reverse for the work vehicle 100.

The steering device 106 includes a steering wheel, a steering shaft connected to the steering wheel, and a power steering device that assists the steering by the steering wheel. The front wheels 104F are steered wheels, and it is possible to change the direction of travel of the work vehicle 100 by changing the steering angle. The steering angle of the front wheels 104F can be changed by operating the steering wheel. The power steering device includes a hydraulic device or an electric motor that supplies auxiliary power to change the steering angle of the front wheels 104F. When automatic steering is performed, the steering angle is automatically adjusted by the force from the hydraulic device or the electric motor as controlled by the controller arranged in the work vehicle 100.

The plurality of pedals 109 include an accelerator pedal, clutch pedal, and a brake pedal. Each pedal can be provided with a sensor that detects being depressed by foot.

A link device 108 is provided at the rear of the vehicle body 101. The link device 108 includes, for example, a 3-point support device (also referred to as a “3-point link” or “3-point hitch”), a PTO (Power Take Off) shaft, a universal joint, and a communication cable. The link device 108 allows the implement 300 to be attached to or detached from the work vehicle 100. The link device 108 can control the position or attitude of the implement 300 by raising or lowering the 3-point link using a hydraulic device, for example. Power can be sent from the work vehicle 100 to the implement 300 via the universal joint. The work vehicle 100 can cause the implement 300 to perform a predetermined task while pulling the implement 300. The link device may be provided at the front of the vehicle body 101. In that case, the implement can be connected to the front of the work vehicle 100.

While the implement 300 shown in FIG. 7 is a rotary tiller, the implement 300 is not limited to a rotary tiller. For example, any implement such as a mower (lawn mower), a seeder (seed sower), a spreader (fertilizer spreader), a rake implement, a baler (lawn collector), a harvester (harvesting machine) a sprayer, or a harrow can be connected to the work vehicle 100.

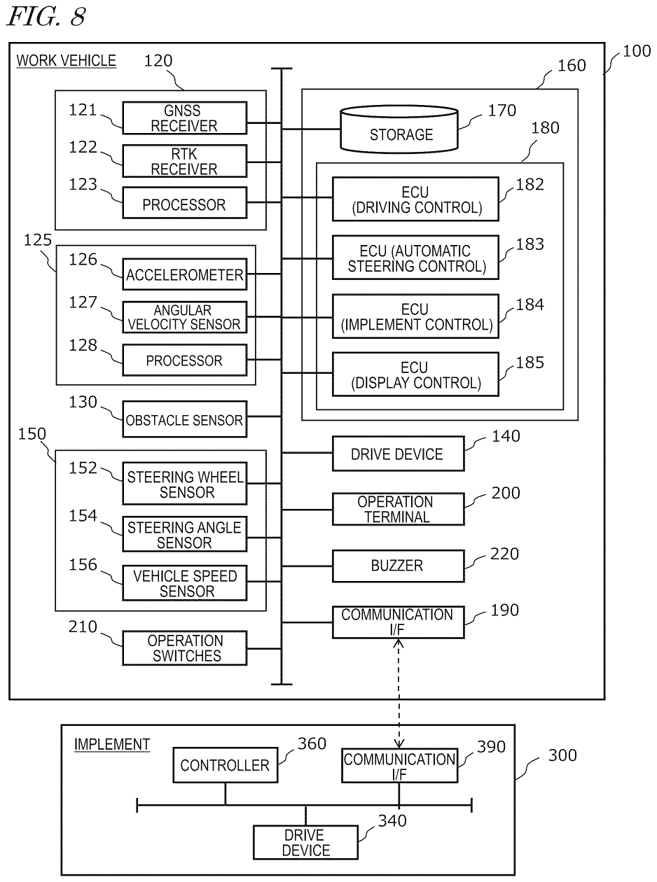

FIG. 8 is a block diagram showing an example schematic configuration of the work vehicle 100 and the implement 300. The work vehicle 100 and the implement 300 can communicate with each other via the communication cable included in the link device 108.

The work vehicle 100 in the example of FIG. 8 includes an inertial measurement unit (IMU) 125, a drive device 140, sensors 150, a control system 160, a communication interface (I/F) 190, operation switches 210, and a buzzer 220 in addition to the positioning device 120, the obstacle sensor 130, and the operation terminal 200. These elements can be connected to one another such that they can communicate with one another via a bus.

The positioning device 120 includes a GNSS receiver 121, an RTK receiver 122, and a processor 123. The inertial measurement unit 125 includes an accelerometer 126, an angular velocity sensor 127, and a processor 128. The sensors 150 include, for example, a steering wheel sensor 152, a steering angle sensor 154, and a vehicle speed sensor 156. The control system 160 includes the storage 170 and a controller 180. The controller 180 includes a plurality of electronic control units (ECU) 182, 183, 184, and 185. The implement 300 includes a drive device 340, a controller 380, and a communication interface (I/F) 390. Note that FIG. 8 shows the elements that are relatively highly relevant to the automatic steering by the work vehicle 100, and the other elements are not shown in the figure.

The GNSS receiver 121 in the positioning device 120 receives satellite signals (also referred to as “GNSS signals”) transmitted from a plurality of GNSS satellites and generates GNSS data based on the satellite signals. The GNSS data is generated in a predetermined format, such as the NMEA-0183 format. The GNSS data may include, for example, values indicating the identification numbers, elevation angles, azimuth angles, and reception strength of satellites from which satellite signals are received. The signal reception strength can be expressed by a value such as the carrier-to-noise power density ratio (C/NO). The GNSS data can also include the position information of the work vehicle 100 calculated based on a plurality of received satellite signals and the information indicative of the reliability of the position information. The position information can be represented by, for example, the latitude, longitude, and height above mean sea level. The reliability of the position information can be represented by, for example, DOP value that indicates the configuration of satellites.

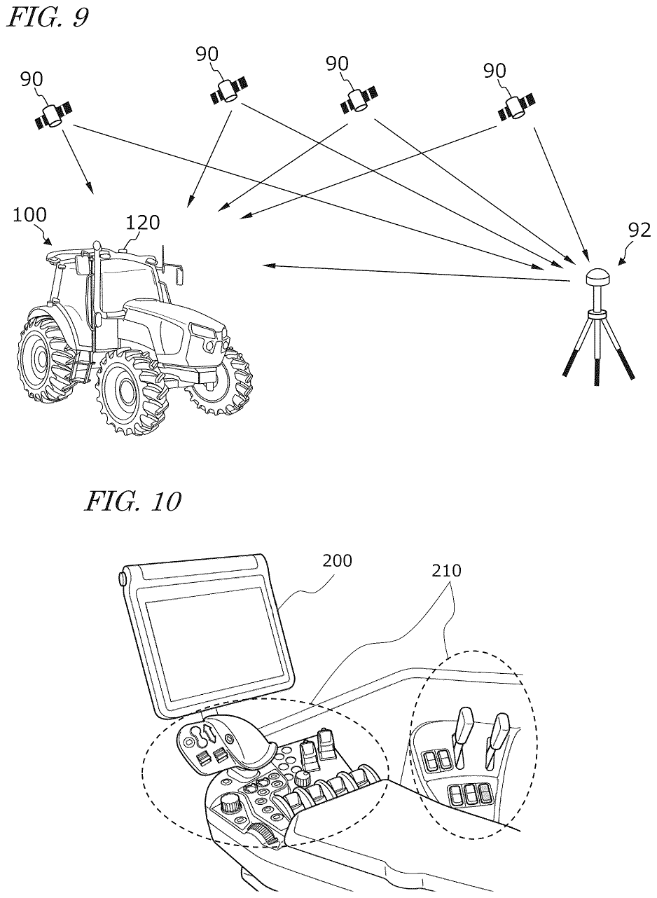

The positioning device 120 shown in FIG. 8 performs positioning of the work vehicle 100 using RTK (Real Time Kinematic)-GNSS. FIG. 9 is a conceptual diagram showing an example of the work vehicle 100 that performs positioning using RTK-GNSS. With the positioning using RTK-GNSS, correction signals transmitted from a reference station 92 are used, in addition to the satellite signals transmitted from a plurality of GNSS satellites 90. The reference station 92 may be installed near the field where the work vehicle 100 performs a tasked travel (e.g., within 10 km of the work vehicle 100). The reference station 92 generates a correction signal in RTCM format, for example, based on satellite signals received from a plurality of GNSS satellites 90, and transmits the correction signal to the positioning device 120. The RTK receiver 122 includes an antenna and a modem, and receives the correction signal transmitted from the reference station 92. The processor 123 of the positioning device 120 corrects the positioning results by the GNSS receiver 121 based on the correction signal. Using RTK-GNSS, it is possible to perform positioning with an accuracy of a few centimeters, for example. Position information including latitude, longitude and altitude is acquired through high-accuracy positioning using RTK-GNSS. The processor 123 of the positioning device 120 calculates the position of the work vehicle 100 at a frequency of about 1 to 10 times per second, for example. The positioning device 120 outputs time series data including information of the calculated position (coordinates).

Note that the positioning method is not limited to RTK-GNSS, and any positioning method may be used (such as interferometric positioning or relative positioning) as long as position information of the required accuracy is obtained. For example, positioning using VRS (Virtual Reference Station) or DGPS (Differential Global Positioning System) may be used. If position information of the required accuracy can be obtained without using the correction signal transmitted from the reference station 92, the position information may be generated without using the correction signal. In such a case, the positioning device 120 may not include an RTK receiver 122.

Instead of the inertial measurement unit 125, the accelerometer 126 and the angular velocity sensor 127 may be separately provided on the work vehicle 100. The accelerometer 126 and the angular velocity sensor 127 are included in the sensors 150. The accelerometer 126 is, for example, a 3-axis accelerometer. The angular velocity sensor 127 is, for example, a 3-axis gyroscope. The processor 128 can output time-series data containing the position and orientation information of the work vehicle 100 by performing the process of, for example, time-integrating the measurement values of the accelerometer 126 and the measurement values of the angular velocity sensor 127. The processor 128 may perform a necessary correction process on the measurement values of the accelerometer 126 and the measurement values of the angular velocity sensor 127 instead of performing the above-described process and output data containing the corrected acceleration and angular velocity and the measurement time information. The inertial measurement unit 125 may include an orientation sensor such as a 3-axis geomagnetic sensor. The inertial measurement unit 125 functions as a motion sensor and can output signals indicating various quantities such as acceleration, speed, displacement, and attitude of the work vehicle 100. The inertial measurement unit 125 can output the signal at a frequency of, for example, several tens to several thousands of times per second.

The positioning device 120 and the inertial measurement unit 125 may be integrated as a single device. The processes of the processors 123 and 128 may be executed by a single processor. At least a portion of the processes of the processors 123 and 128 may be executed by a processor included in the controller 180. Such a processor can estimate the position and orientation of the work vehicle 100 with higher accuracy based on signals output from the inertial measurement unit 125 in addition to the GNSS signals and the correction signals. The signals output from the inertial measurement unit 125 can be used to correct or complement the position calculated based on the GNSS signals and the correction signals. The inertial measurement unit 125 can output signals at a higher frequency than the positioning device 120. The position and orientation of the work vehicle 100 can be measured at a higher frequency (e.g., 10 Hz or higher) using such high-frequency signals.

The positioning device 120 may include other types of sensors, such as a LIDAR sensor or an image sensor, in addition to or instead of the GNSS receiver 121 and the RTK receiver 122. If there are geographic objects in the environment in which the work vehicle 100 is traveling that function as landmarks, the position and orientation of the work vehicle 100 can be estimated by matching sensor data output from these sensors with an environment map. With such a configuration, an external sensor such as a LiDAR sensor or an image sensor may be included in the positioning device.

The drive device 140 includes various devices to drive the work vehicle 100 and driving the implement 300, such as the prime mover 102, the transmission 103, the steering device 106, and the link device 108 described above. The prime mover 102 may include an internal combustion engine, such as a diesel engine. The drive device 140 may include an electric motor for traction instead of or in addition to the internal combustion engine.

The steering wheel sensor 152 measures the rotation angle of the steering wheel of the work vehicle 100. The steering angle sensor 154 measures the steering angle of the front wheels 104F, which are steered wheels. The vehicle speed sensor 156 is a sensor that measures the traveling speed (vehicle speed) of the work vehicle 100.

The vehicle speed sensor 156 can be configured to measure, for example, the rotation speed of the axle connected to the wheels 104, i.e., the number of rotations per unit time. The thus-configured vehicle speed sensor 156 can include a magnetoresistive element (MR), a Hall element, or an electromagnetic pickup. The vehicle speed sensor 156 can be configured to output a pulse signal proportional to the rotation speed of the gear included in the transmission, for example.

The measurement values taken by the steering wheel sensor 152, the steering angle sensor 154, and the vehicle speed sensor 156 are used in steering control by the controller 180.

The storage 170 includes one or more storage medium, such as a flash memory or a magnetic disk. The storage 170 stores various data generated by the sensors and the controller 180. The data stored in the storage 170 may include map data of the environment in which the work vehicle 100 travels and data of the target route for automatic steering. The storage 170 also stores computer programs that cause the ECUs in the controller 180 to perform the various operations to be described below. Such computer programs may be provided to the work vehicle 100 via a storage medium (e.g., a semiconductor memory or an optical disc) or an electrical communication line (e.g., the Internet). Such a computer program(s) may be marketed as commercial software.

The controller 180 includes a plurality of ECUs. The plurality of ECUs include the ECU 182 configured or programmed to perform driving control, the ECU 183 configured or programmed to perform automatic steering control, the ECU 184 configured or programmed to perform implement control, and the ECU 185 configured or programmed to perform display control. The ECU 182 is configured or programmed to control the speed of the work vehicle 100 by controlling the prime mover 102, the transmission 103, the accelerator, and the brake included in the drive device 140. Also, the ECU 182 is configured or programmed to control the steering of the work vehicle 100 by controlling the hydraulic device or the electric motor included in the steering device 106 based on the measurement values of the steering wheel sensor 152. The ECU 183 is configured or programmed to perform calculation and control to achieve the automatic steering driving based on signals output from the positioning device 120, the inertial measurement unit 125, the steering wheel sensor 152, the steering angle sensor 154, the vehicle speed sensor 156, etc. The ECU 183 is configured or programmed to perform the functions as the controller 50 shown in FIG. 1 and makes corrections to the steering angle by the method described with reference to FIG. 2 through FIG. 5. During automatic steering driving, the ECU 183 is configured or programmed to send a steering angle change instruction to the ECU 182. The ECU 182 is configured or programmed to change the steering angle by controlling the steering device 106 in response to the instruction. The ECU 184 is configured or programmed to control the operation of the link device 108 in order to make the implement 300 perform the desired operation. The ECU 184 is configured or programmed to also generate signals to control the operation of the implement 300, and transmits the signal from the communication I/F 190 to the implement 300. The ECU 185 is configured or programmed to control the display of the operation terminal 200. The ECU 185, for example, is configured or programmed to cause the display device of the operation terminal 200 to display various items, such as a map of the field, the position of the work vehicle 100 and the target route on the map, pop-up notifications, and the setting screen.

With the operation of these ECUs, the controller 180 is configured or programmed to realize driving by manual steering or automatic steering. During automatic steering driving, the controller 180 is configured or programmed to determine the steering command angle for the steered wheels based on the position and orientation of the work vehicle 100, which is measured or estimated by the positioning device 120 and the inertial measurement unit 125, and the target route stored in the storage 170. The controller 180 is configured or programmed to correct the determined steering command angle by the method described with reference to FIG. 2 through FIG. 5 and controls the drive device 140 based on the corrected steering command angle. Thus, the controller 180 enables the work vehicle 100 to travel along the target route. Note that the controller 180 may be configured or programmed to automatically control not only the steering of the work vehicle 100 but also the vehicle speed. In other words, the controller 180 may be configured or programmed to operate in an automatic traveling mode in which the work vehicle 100 automatically travels along a pre-set target route.

The plurality of ECUs included in the controller 180 can communicate with each other according to a vehicle bus standard, such as CAN (Controller Area Network), for example. In FIG. 8, the ECUs 182, 183, 184, and 185 are shown as individual blocks, but their functions may each be implemented by a plurality of ECUs. An in-vehicle computer that integrates at least some of the functions of the ECU 182, 183, 184, and 185 may be provided. The controller 180 may include ECUs other than the ECUs 182, 183, 184, and 185. Any number of ECUs may be provided according to the functions. Each ECU includes a control circuit containing one or more processors.

The communication I/F 190 is a circuit to communicate with a communication I/F 390 of the implement 300. The communication I/F 190 exchanges signals in conformity with the ISOBUS standard, such as ISOBUS-TIM, with the communication I/F 390 of the implement 300. This allows the implement 300 to perform desired operations and to acquire information from the implement 300. The communication I/F 190 may communicate with an external computer via a wired or wireless network. The external computer may be a server computer in an agricultural management system that centrally manages information regarding fields, for example, on a cloud and supports agriculture by utilizing data on the cloud.

The operation terminal 200 is a terminal for the user to perform operations related to the travel of the work vehicle 100 and the operation of the implement 300, and is also referred to as a virtual terminal (VT). The operation terminal 200 may include a display device such as a touch screen and/or one or more buttons. By operating the operation terminal 200, the user can perform various operations, such as switching the automatic steering mode on and off, setting the initial position of the work vehicle 100, setting the target route, recording or editing maps, and switching the implement 300 on and off. At least some of these operations may also be realized by operating the operation switches 210. The display on the operation terminal 200 is controlled by the ECU 185.

The buzzer 220 is a sound output device that emits warning sounds to notify the user of abnormalities. For example, the buzzer 220 emits a warning sound when the work vehicle 100 deviates from the target route by a predetermined distance or more during automatic steering driving. Instead of the buzzer 220, a similar function may be achieved by the speaker of the operation terminal 200.

The drive device 340 in the implement 300 performs the operation necessary for the implement 300 to perform predetermined work. The drive device 340 includes a device in accordance with the application of the implement 300, such as a hydraulic device, an electric motor, or a pump. The controller 380 is configured or programmed to control the operation of the drive device 340. The controller 380 is configured or programmed to cause the drive device 340 to perform various operations in response to signals transmitted from the work vehicle 100 via the communication I/F 390. Also, signals corresponding to the status of the implement 300 can be transmitted from the communication I/F 390 to the work vehicle 100.

FIG. 10 is a diagram showing an example of the operation terminal 200 and the operation switches 210 provided inside the cabin 105. The switches 210, which include a plurality of switches that can be operated by the user, are arranged inside the cabin 105. The switches 210 can include, for example, a switch to switch between the automatic steering (auto-steer) mode and the manual steering (manual steer) mode, a switch to switch between forward and reverse (e.g., a shuttle lever or a shuttle switch), a switch to select the main transmission gear or the auxiliary transmission gear, and a switch to raise and lower the implement 300.

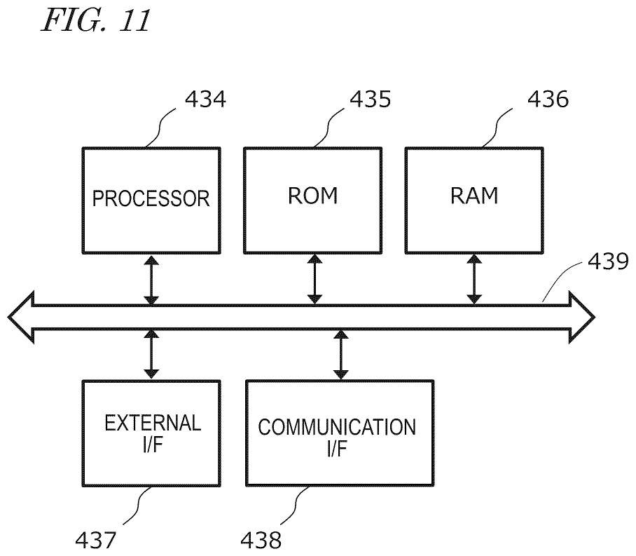

FIG. 11 is a block diagram showing an example hardware configuration of each ECU. Each ECU includes a processor 434, a ROM 435, a RAM 436, an external I/F 437, and a communication I/F 438. These components are interconnected via a bus 439.

The ROM 435 is, for example, a writable memory (e.g., PROM), a rewritable memory (e.g., flash memory), or a read-only memory. The ROM 435 stores a program that controls the operation of the processor 434. The ROM 435 does not need to be a single storage medium, but may be a collection of a plurality of storage mediums. Some of the plurality of storage mediums may be removable memories.

The RAM 436 provides a work area for temporarily expanding the program stored in the ROM 435 at boot. The RAM 436 does not need to be a single storage medium, and may be a collection of a plurality of storage mediums.

The external I/F 437 is an interface for connection with external devices. The communication I/F 438 is an interface for communication with other electronic devices (e.g., sensors and other ECUs). For example, the communication I/F 438 can perform wired communication in compliance with various protocols such as CAN or Ethernet (registered trademark). The communication I/F 438 may perform wireless communication in compliance with wireless communication standards such as Bluetooth (registered trademark) and/or Wi-Fi (registered trademark).

The ECU may further include a storage capable of retaining data generated by the processor 434 for a relatively long period of time. Such a storage may be, for example, a semiconductor storage, a magnetic storage or an optical storage, or a combination thereof.

Next, the operation of the work vehicle 100 will be described. The controller 180 in the present example embodiment can be configured or programmed to switch between the manual driving mode and the automatic steering mode in response to the operation by the user (e.g., driver) of the work vehicle 100. In the manual driving mode, the controller 180 is configured or programmed to control steering by driving the power steering device in response to the operation of the steering wheel by the user. In the automatic steering mode, the controller 180 is configured or programmed to control steering by driving the power steering device based on the position and orientation (orientation) of the work vehicle 100 estimated based on data output from the positioning device 120 and the inertial measurement unit 125, and a target route recorded in advance. Also in the automatic steering mode, the speed is adjusted by an acceleration operation and a braking operation by the user.

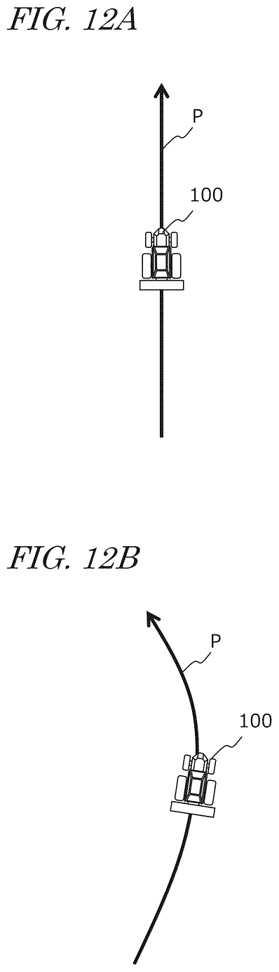

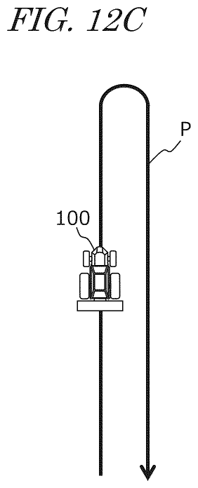

FIG. 12A to FIG. 12C are diagrams showing examples of how the work vehicle 100 travels in the automatic steering mode. FIG. 12A schematically shows how the work vehicle 100 travels along a straight target route P. FIG. 12B schematically shows how the work vehicle 100 travels along a curved target route P. FIG. 12C schematically shows how the work vehicle 100 travels along a target route P that includes two adjacent straight routes and a curved route that connects them. The target route P is pre-set and is recorded in the storage 170. When the work vehicle 100 is traveling in the automatic steering mode, the controller 180 is configured or programmed to repeatedly calculate the deviation between the target route P and the position and orientation of the work vehicle 100 estimated based on the data output from the positioning device 120 and the inertial measurement unit 125 and control the steering device so as to reduce the deviation. This causes the work vehicle 100 to travel along the target route P.

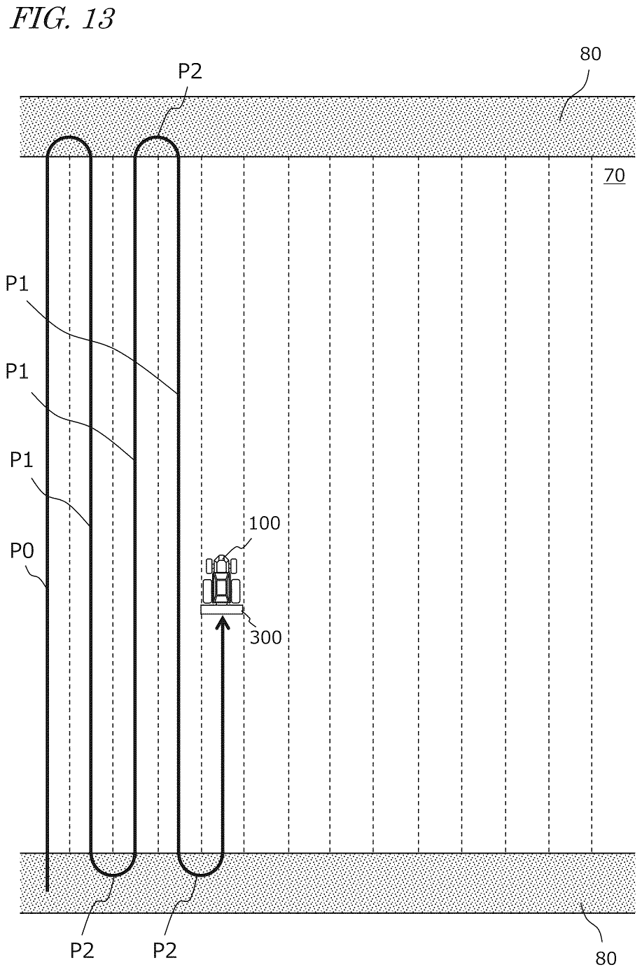

FIG. 13 is a diagram schematically showing an example of the target route for the work vehicle 100 traveling in a field by automatic steering. In this example, the field includes a work area 70 in which the work vehicle 100 and the implement 300 perform work, and a headland 80 located around the outer edge of the field. The user can set in advance which areas of the field correspond to a work area 70 and the headland 80 on the map, by operating the operation terminal 200. The target route includes a plurality of parallel main routes P1 and a plurality of turning routes P2 that connect together the plurality of main routes P1. The main routes P1 are located within the work area 70, and the turning routes P2 are located in the headland 80. The dashed line intervals in FIG. 13 represent the working width of the implement 300. The working width is set in advance and recorded in the storage 170. The working width may be set by the user operating the operation terminal 200 and recorded in the storage 170. Alternatively, the working width may be automatically recognized when the implement 300 is connected to the work vehicle 100 and recorded in the storage 170. The interval between the plurality of main routes P1 is adjusted to the working width. The target route may be determined based on the user's operation before automatic steering driving is started.

Next, an example of control during automatic steering by the controller 180 will be described.

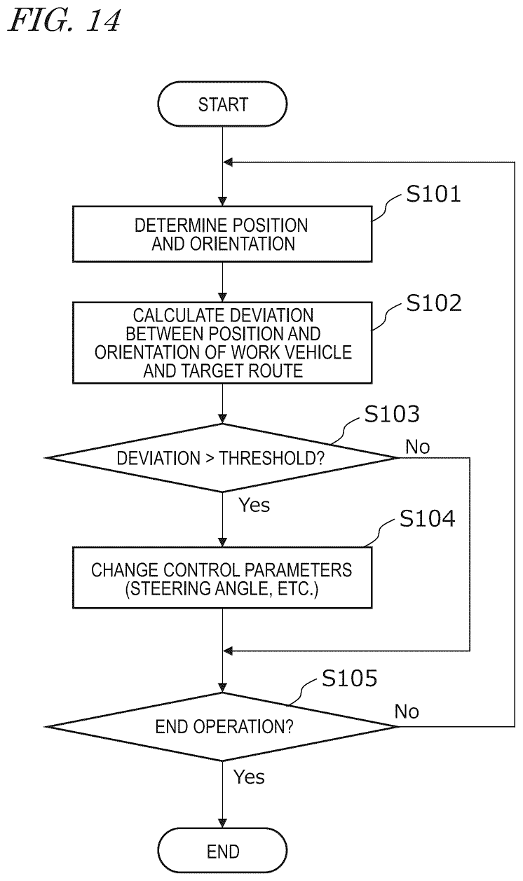

FIG. 14 is a flow chart showing an example of the operation performed during automatic steering by the controller 180. The controller 180 is configured or programmed to perform automatic steering driving by executing the operations of steps S101 to S105 shown in FIG. 14 while the work vehicle 100 is traveling. Before the operations shown in FIG. 14, the controller 180 is configured or programmed to determine the steering angle correction parameter by the method described with reference to FIG. 2 through FIG. 5. After that, the controller 180 is configured or programmed to execute the operations from Step S101 to Step S105.

The controller 180 is configured or programmed to first estimate the position and the orientation of the work vehicle 100 based on data output from the positioning device 120 and the inertial measurement unit 125 (step S101). Next, the controller 180 is configured or programmed to calculate the deviation between the position and the orientation of the work vehicle 100 and the target route (step S102). The position deviation represents the distance between the position of the work vehicle 100 at that point in time and the target route. The directional deviation represents the magnitude of the angle between the orientation of the work vehicle 100 at that point in time and the direction of the target route. The controller 180 is configured or programmed to determine whether the calculated position deviation exceeds a predetermined threshold value, and whether the calculated directional deviation exceeds another predetermined threshold value (step S103). If at least one of the position deviation and the directional deviation exceeds the respective threshold value, the controller 180 is configured or programmed to change the steering angle by changing the control parameters for the steering device included in the drive device 140 so as to decrease the deviation. In this change of the steering angle, the results of the steering angle correction based on the above-described correction parameters are reflected. If neither the position deviation nor the directional deviation exceeds the respective threshold in step S103, the operation of step S104 is omitted. Subsequently, at Step S105, the controller 180 is configured or programmed to determine whether or not it has received an instruction to terminate the operation. The instruction to terminate the operation can be issued, for example, when the user instructs the termination of the automatic steering mode using the operation terminal 200 or when the work vehicle 100 reaches its destination. If no instruction to terminate the operation has been issued, the process returns to Step S101, and the same operation is executed based on the newly measured position of the work vehicle 100. The controller 180 is configured or programmed to repeat the operations from Step S101 to S105 until an instruction to terminate the operation is issued. This operation is performed by the ECU 183 in the controller 180.

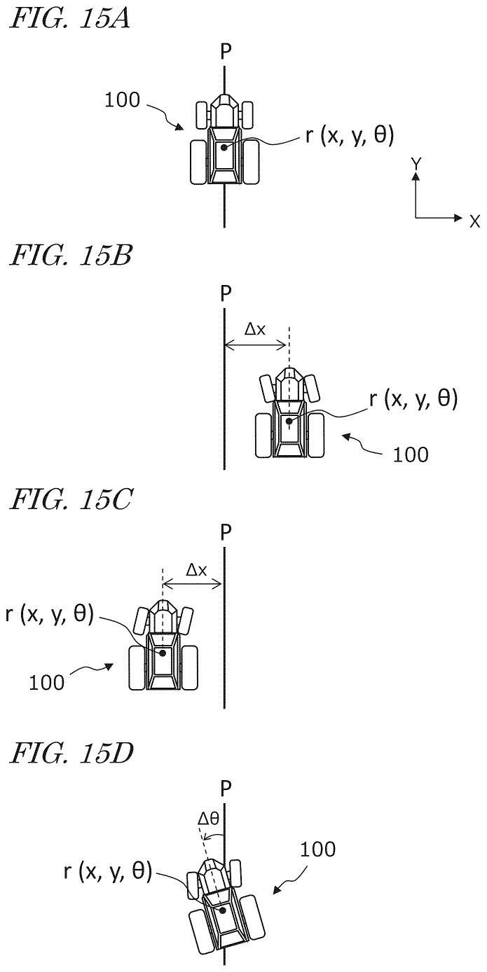

Referring to FIG. 15A to FIG. 15D, an example of steering control by the controller 180 will be described in more detail.

FIG. 15A is a diagram showing an example of the work vehicle 100 traveling along the target route P. FIG. 15B is a diagram showing an example of the work vehicle 100 located at a position shifted to the right from the target route P. FIG. 15C is a diagram showing an example of the work vehicle 100 located at a position shifted to the left from the target route P. FIG. 15D is a diagram showing an example of the work vehicle 100 oriented in a direction inclined relative to the target route P. In these figures, the pose, which indicates the position and orientation of the work vehicle 100 as estimated based on signals output from the positioning device 120 and the inertial measurement unit 125, is expressed as r(x,y,θ). (x,y) are the coordinates indicating the position of the reference point of the work vehicle 100 in the XY coordinate system, which is a two-dimensional coordinate system fixed to the earth. In the examples shown in FIG. 15A to FIG. 15D, the reference point of the work vehicle 100 is at the location where the GNSS antenna is installed on the cabin, but the location of the reference point is arbitrary. 0 is an angle that represents the measured orientation of the work vehicle 100. In the illustrated examples, the target route P is parallel to the Y axis, but in general, the target route P is not necessarily parallel to the Y axis.

As shown in FIG. 15A, if the position and orientation of the work vehicle 100 are not deviated from the target route P, the controller 180 does not change but maintains the steering angle and the speed of the work vehicle 100.

As shown in FIG. 15B, if the position of the work vehicle 100 is shifted to the right from the target route P, the controller 180 changes the steering angle by changing the rotation angle of the steering wheel included in the drive device 140 so that the travel direction of the work vehicle 100 tilts to the left to be closer to the route P. At this time, the speed may also be changed in addition to the steering angle. The magnitude of the steering angle may be adjusted in accordance with the magnitude of the position deviation Δx, for example.

As shown in FIG. 15C, if the position of the work vehicle 100 is shifted to the left from the target route P, the controller 180 changes the steering angle by changing the rotation angle of the steering wheel so that the travel direction of the work vehicle 100 tilts to the right to be closer to the route P. Also in this case, the speed may also be changed in addition to the steering angle. The amount of change in the steering angle may be adjusted in accordance with the magnitude of the position deviation Δx, for example.

As shown in FIG. 15D, if the position of the work vehicle 100 is not significantly off the target route P, but the orientation is different from the direction of the target route P, the controller 180 is configured or programmed to change the steering angle so as to reduce the directional deviation Δθ. Also in this case, the speed may also be changed in addition to the steering angle. The magnitude of the steering angle may be adjusted in accordance with the magnitude of the position deviation Δx and the magnitude of the directional deviation Δθ, for example. For example, the smaller the absolute value of the position deviation Δx, the larger the amount of change in the steering angle in accordance with the directional deviation Δθ may be. Where the absolute value of the position deviation Δx is large, the steering angle will need to be changed greatly in order to return to the route P, which will result in the absolute value of the directional deviation Δθ being large. Conversely, where the absolute value of the position deviation Δx is small, the directional deviation Δθ needs to be brought close to zero. For this reason, it is appropriate to make relatively large the weight (i.e., control gain) of the directional deviation Δθ for determining the steering angle.

Control techniques such as PID control or MPC control (model predictive control) can be applied to the steering control and speed control of the work vehicle 100. By applying these control techniques, it is possible to smoothly control the work vehicle 100 to come closer to the target route P.

Through the above-described operations, automatic steering is realized which enables the work vehicle 100 to travel along the target route P. According to the present example embodiment, at Step S104, the steering angle correction is performed based on the correction parameters α and β predetermined by the method shown in FIG. 5, for example. This enables further reduction of the deviation from the target route P during automatic steering driving. Since, as previously described, the correction parameters α and β can be continuously updated during usual traveling, deterioration of the steering control accuracy due to deterioration over time can be suppressed. In the example embodiment described above, the work vehicle 100 may be a work vehicle that performs automated driving unmanned. In that case, elements that are only necessary for human driving, such as the cabin, the driver seat, the steering wheel, and the operation terminal, may not be provided in the work vehicle 100. The unmanned work vehicle may perform the same operations as those in the example embodiment described above by autonomous traveling or remote control by the user.

The controller in the above-described example embodiment can also be retrofitted to vehicles that do not have those functions. Such controller can be manufactured and sold independently of vehicles. Computer programs used in such controllers can also be manufactured and sold independently of vehicles. Computer programs can be provided, for example, stored in a computer-readable non-transitory storage medium. Computer programs can also be provided as downloads via an electrical telecommunication line (e.g., the Internet).

The technologies of example embodiments of the present disclosure can be applied to work vehicles used in agricultural applications, such as tractors, transplanters, or harvesters. The technologies of example embodiments of the present disclosure can also be applied to work vehicles used in non-agricultural applications, such as construction work vehicles or snowplows. Furthermore, the technologies of example embodiments of the present disclosure can also be applied to general vehicles such as passenger cars.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A controller for controlling steering of a vehicle, the controller comprising:
one or more processors; and
one or more memories storing a computer program to be executed by the one or more processors to perform:
obtaining sensor data from one or more sensors provided on the vehicle for use in determining a curvature of a route along which the vehicle is traveling;
determining the curvature based on the sensor data; and
correcting a steering angle of a steered wheel of the vehicle based on the curvature.

2. The controller of claim 1, wherein the one or more processors is/are configured or programmed to correct the steering angle based on the curvature and a wheelbase of the vehicle.

3. The controller of claim 1, wherein the one or more sensors include:
a vehicle speed sensor to measure a traveling speed of the vehicle; and
an angular velocity sensor to measure an angular velocity about a yaw axis of the vehicle; wherein
the one or more processors is/are configured or programmed to determine the curvature based on the traveling speed and the angular velocity.

4. The controller of claim 3, wherein the one or more processors is/are configured or programmed to determine the curvature based on a relationship κ=ω/v where v is the traveling speed, ω is the angular velocity, and κ is the curvature.

5. The controller of claim 4, wherein
the one or more processors is/are configured or programmed to determine a first error coefficient α and a second error coefficient β based on a relationship:
$$κ = tan ( δ \times β + α ) / L , \qquad Equation 1$$
where δ is the steering angle of the vehicle before correction, L is a wheelbase, a is the first error coefficient, and β is the second error coefficient; and
the one or more processors is/are configured or programmed to correct the steering angle based on the first error coefficient α and the second error coefficient β.

6. The controller of claim 5, wherein
the one or more sensors include a steering angle sensor to measure the steering angle of the vehicle;
the one or more processors is/are configured or programmed to determine the curvature κ based on the traveling speed v and the angular velocity ω during a period in which the vehicle is traveling while an absolute value of the measured steering angle is smaller than a first threshold; and
the one or more processors is/are configured or programmed to determine the first error coefficient α based on a relationship κ=tan(α)/L, obtained by substituting δ=0 into Equation 1.

7. The controller of claim 6, wherein the one or more processors is/are configured or programmed to determine the second error coefficient β based on the determined first error coefficient α, the curvature κ determined based on the traveling speed v and the angular velocity ω during a period in which the vehicle is traveling while the absolute value of the steering angle is greater than a second threshold, and Equation 1.

8. The controller of claim 5, wherein the one or more processors is/are configured or programmed to continuously update the first error coefficient α and the second error coefficient β while the vehicle is traveling and correct the steering angle based on the updated first error coefficient α and the updated second error coefficient β.

9. The controller of claim 1, wherein the one or more processors is/are configured or programmed to select a portion of the sensor data obtained while the vehicle is traveling, to be used in determining the curvature, based on at least one of contents of the sensor data or a travel condition of the vehicle.

10. The controller of claim 1, wherein
the vehicle is capable of operating in an automatic steering mode; and
the one or more processors is/are configured or programmed to:
determine a steering command angle based on a target route and a position of the vehicle;
determine a steering angle correction parameter based on the curvature;
correct the steering command angle based on the steering angle correction parameter; and
control steering of the vehicle based on the corrected steering command angle.

11. The controller of claim 1, wherein
the vehicle is capable of operating in an automatic steering mode; and
in the automatic steering mode, the one or more processors is/are configured or programmed to:
obtain information indicative of a measured position of the vehicle from a positioning device provided on the vehicle;
retrieve information indicative of a target route of the vehicle from a storage;
determine a steering command angle based on the measured position and the target route;
determine a steering angle correction parameter based on the curvature;
correct the steering command angle based on the steering angle correction parameter; and
control steering of the vehicle based on the corrected steering command angle.

12. The controller of claim 1, wherein the vehicle is an agricultural tractor.

13. A vehicle comprising:
the controller as set forth in claim 1;
the one or more sensors;
a drivetrain including a steered wheel; and
an actuator to drive the steered wheel based on an instruction from the controller.

14. A method executed by one or more computers to control steering of a vehicle, the method comprising:
obtaining sensor data from one or more sensors provided on the vehicle for use in determining a curvature of a route along which the vehicle is traveling;
determining the curvature based on the sensor data; and
correcting a steering angle of a steered wheel of the vehicle based on the curvature.

15. A non-transitory computer-readable medium including a computer program executable by one or more computers to control steering of a vehicle, the computer program causing the one or more computers to:
obtain sensor data from one or more sensors provided on the vehicle for use in determining a curvature of a route along which the vehicle is traveling;
determine the curvature based on the sensor data; and
correct a steering angle of the vehicle based on the curvature.
